(19) United States
(12) Patent Application Publication
(10) Pub. No.: US 2007/0057177 A1
(43) Pub. Date: Mar. 15, 2007

(54) Non-linear ion post-focusing apparatus and mass spectrometer using the same

(75) Inventors: Dukhyein Kim, Daejeon (KR); Hyungki Cha, Daejeon (KR); Kiho Yang, Daejeon (KR)

Correspondence Address: NIXON & VANDERHYE, PC, 901 NORTH GLEBE ROAD, 11TH FLOOR, ARLINGTON, VA, 22203, US

(73) Assignee: KOREA ATOMIC ENERGY RESEARCH INSTITUTE, Yuseong-gu (KR)

(21) Appl. No.: 11/516,597

(22) Filed: Sep. 7, 2006

(30) Foreign Application Priority Data
Sep. 9, 2005 (KR) 10-2005-0084319

(51) Int. Cl. H01J 49/04

(52) U.S. Cl. 250/287

(57) ABSTRACT

A mass spectrometer system and a mass spectrometry method, in which a mass resolution is increased through a non-linear ion post-focusing apparatus so as to more accurately analyze constituents of components contained in a dust particle. The mass spectrometer system according to the present invention comprises: an ion-introducing unit for introducing particles into the mass spectrometer system; an ionization unit for ionizing the introduced particles to generate ions; an ion-accelerating unit for accelerating the generated ions with different electric fields depending on respective positions of the ions; and an ion mass detector for detecting the mass of the accelerated ions. According to the present invention, the inventive mass spectrometer system uses a non-linear ion post-focusing apparatus to cause even ions whose initial energies and initial directions are different from one another to be incident on the TOF ion sensor concurrently, thereby increasing the resolution of the mass-to-charge of ions.

### CROSS-REFERENCE TO RELATED APPLICATION

This application claims the benefit of Korean Patent Application No. 10-2005-0084319, filed on Sep. 9, 2005, in the Korean Intellectual Property Office, the disclosure of which is incorporated herein by reference.

### BACKGROUND OF THE INVENTION

1. Field of the Invention

The present invention relates to a mass spectrometer and a mass spectrometry method which can analyze components of a dust contained in the air, and more particularly to a mass spectrometer system and a mass spectrometry method, in which a mass resolution is increased through a non-linear ion post-focusing apparatus so as to more accurately analyze constituents of components contained in a dust particle.

2. Background of the Related Art

Currently, an apparatus has been developed which measures the components of a dust contained in the air in real time and its application to various environmental and meteorological research is becoming increasingly pursued. In addition, many researches are now in progress to improve, particularly, mass spectrometry resolution among performances of such a measurement apparatus. The improvement of the resolution is aimed to enable the mass spectrometer to rapidly cope with the cause of pollution by more accurately analyzing aerosol as very small solid or liquid particles floating in the atmosphere in real time in view of fact that the atmospheric aerosol represents the ambient environment.

In general, the mass spectrometer is an instrument which accelerates an ion and allows the accelerated ion to pass through an electric field or magnetic field so as to change its advance direction to thereby analyze a mass spectrum representing the masses of sample components. This mass spectrometer desorbs atoms constituting particles from the particles by means of a laser or other methods, re-ionizes the desorbed atoms, and applies an electric force to the re-ionized atoms so as to accelerate the ions. The mass spectrometer permits the ions to be accelerated in direct proportion to their masses and the degree of ionization. At this time, if the mass-to-charge ratio of the ions is constant, the ions move at a constant speed within a free electric field of the mass spectrometer. As a result, the arrival time of the ions at an ion sensor can be measured by the ion sensor so as to identify components of a corresponding substance sample.

FIG. 1 is schematic view illustrating the construction of a conventional aerosol mass spectrometer according to the conventional art.

Referring to FIG. 1, the aerosol mass spectrometer allows aerosols 101 to pass through two or more skimmers 103 and 104 using a vacuum pump so as to be introduced into a desired space of the aerosol mass spectrometer. The aerosol mass spectrometer measures the speed of aerosols being introduced to find the size of an aerosol particles, simultaneously predicts the path of the aerosol particles based on the measured speed of aerosols, and irradiates a beam from a high energy laser onto the trajectory of the aerosol particles to thereby analyze components of the particles according to the size of the aerosol particles. The aerosol mass spectrometer allows respective components constituting the aerosol particles to be subjected to desorption and ionization processes by means of a high-power pulse laser 110. In the above desorption and ionization processes, since the aerosols are placed in a vacant space unlike an ionization process of other laser-induced medium analysis systems, ions progress in all directions around 360 degrees. That is, the aerosol particles ionized in the above desorption and ionization processes are dispersed in all 360 degree directions, and the initial energy of the ions depends on the temperature of plasma determined by the output power of the laser. Thus, this is the same as the case where various particles having different initial energies exist concurrently from the point of view of a conventional time-of-flight (TOF) mass spectrometer.

As such, since the ions are generated with them having different initial energies when being dispersed in diverse directions, a mass resolution of the conventional TOF mass spectrometer is deteriorated.

The conventional mass spectrometer typically ionizes aerosols between two electrode plates 107 and 108 having a potential difference generated therebetween so as to introduce desired packets of ions into a TOF chamber. When voltage is applied across the two electrode plates 107 and 108 so that they generate an electric potential greater than the kinetic energy of particles having the maximum initial energy, all the ions move in only one direction due to the electric potential generated between the two electrode plates 107 and 108.

However, the conventional mass spectrometer entails a shortcoming that since it is required to secure a large enough space for the high-power pulse laser to irradiate a laser beam onto the aerosol particles between the two electrode plates 107 and 108, the distance between the electrode plates inevitably becomes large, making it difficult to sufficiently accelerate the ions. Therefore, such a conventional mass spectrometer also provides an ion-accelerating electrode plate 109 to sufficiently accelerate ions having unidirectionality in their propagation path and then introduce the accelerated ions into a free electric field tube region 111 of the TOF mass spectrometer to thereby reach an ion sensor 113.

As such, the conventional mass spectrometer also suffers from a demerit that since respective introduced ions pass through diverse trajectories within the free electric field tube 111 depending on the initial movement direction or the size of the initial kinetic energy of the ions, there is a difference in the time required for the ions to reach the ion sensor 113, such that the discrimination between ions according to the mass-to-charge ratio (q/m, where q: charge, m: mass) of the ions becomes difficult, resulting in a degradation in mass resolution of the mass spectrometer.

That is, the conventional aerosol mass spectrometer has a disadvantage in that although the ions have the same mass and the same charge, it takes different time for them to reach the ion sensor depending on the initial movement direction or the kinetic energy of the ions, which makes it impossible to accurately detect the magnitude of the masses of the sample components.

In an attempt to address and solve the above-mentioned problems, U.S. Pat. No. 5,742,049 entitled ‘Method of improving mass resolution in time-of-flight mass spectrometer’ among various methods has been proposed. However, the '049 patent has a demerit that it is complicated in its structure. In addition, other conventional methods entail a disadvantage that it is required to change an accelerating voltage in a short time, and excellent mass resolution is not improved in a broad energy region upon the application of a certain voltage.

### SUMMARY OF THE INVENTION

Accordingly, the present invention has been made in view of the aforementioned problems occurring in the conventional art, and it is an object of the present invention to provide a mass spectrometer system including an ion post-focusing apparatus which applies a static post-focusing electric field to ions to be able to achieve an excellent resolution with respect to the mass of the stream of charged particles having an initial energy of a sufficiently broad range, and a mass spectrometry method.

Another object of the present invention is to provide a mass spectrometer system and a mass spectrometry method using an ion post-focusing apparatus which is adapted to complement an ion-accelerating unit so as to improve sensitivity of the system by using all of the ions.

To accomplish the above object, according to one aspect of the present invention, there is provided a mass spectrometer system including: an ion-introducing unit for introducing particles into the mass spectrometer system; an ionization unit for ionizing the introduced particles to generate ions; an ion-accelerating unit for accelerating the generated ions with different electric fields depending on respective positions of the ions; and an ion mass detector for detecting mass of the accelerated ions.

To accomplish the above object, according to another aspect of the present invention, there is provided a mass spectrometry method using a mass spectrometer system including: introducing particles into the mass spectrometer system; ionizing the introduced particles to generate ions; accelerating the generated ions with different electric fields depending on respective positions of the ions; and detecting the mass of the accelerated ions.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is schematic diagram illustrating the construction of a general aerosol mass spectrometer (AMS) according to the conventional art;

FIG. 2 is a schematic diagram illustrating the construction of an apparatus for extracting, accelerating, and post-focusing ions in a mass spectrometer system according to an exemplary embodiment of the present invention;

FIG. 3 is a graph illustrating the position of packets of ions before the secondary ion post-focusing process is performed in a mass spectrometer system according to the present invention;

FIG. 4 is a graph illustrating the total energy distribution of packets of ions before the secondary ion post-focusing process is performed in a mass spectrometer system according to the present invention;

FIG. 5 is a graph illustrating the voltage distribution of an ion post-focusing plate for use in the secondary ion post-focusing process in a mass spectrometer system according to the present invention; and

FIG. 6 is a timing graph illustrating waveforms of TOF signals of various ions whose initial energies and initial directions are different from one another, respectively, in a mass spectrometer system according to the present invention; and

FIG. 7 is a flowchart illustrating a mass spectrometry process performed using a mass spectrometer system according to one embodiment of the present invention.

### DETAILED DESCRIPTION OF THE PREFERRED EMBODIMENT

Reference will now be made in detail to a mass spectrometer system and a mass spectrometry method according to a preferred embodiment of the present invention with reference to the attached drawings. The present invention is not limited by or to a specific embodiment.

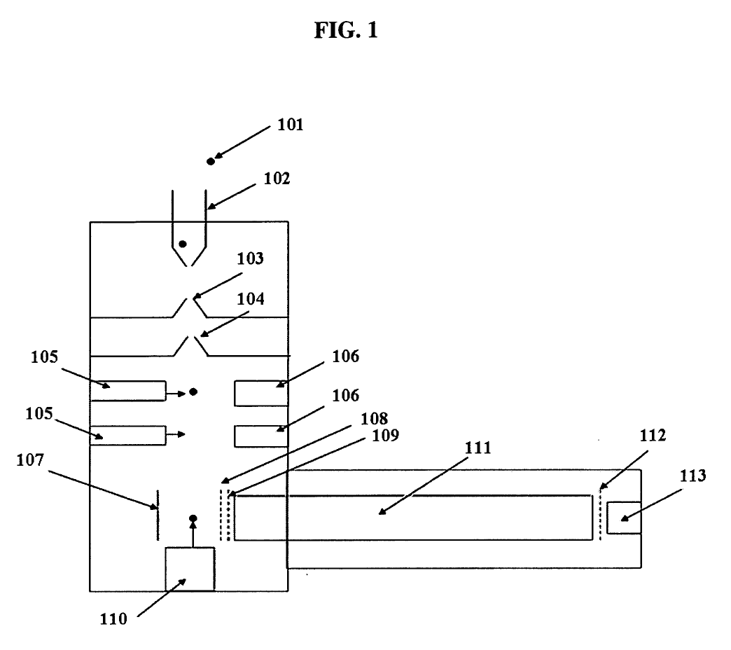

A particle introducing apparatus of the mass spectrometer system according to the present invention is implemented based on the same principle as that of a general mass spectrometer shown in FIG. 1.

The particle introducing apparatus employs a differential pumping method to introduce aerosol particles existing under a high vacuum state of approximately 10⁻⁷ mbar. As shown in FIG. 1, the particle introducing apparatus includes one aerosol injection nozzle 101 and two skimmers 103 and 104. The mass spectrometer system according to the present invention measures the speed of the introduced aerosol particles through an optical system composed of continuous-wave lasers 105 and optical sensors 106, and activates a high-power pulse laser 110 for ionizing the aerosol particles based on the measured speed of the aerosol particles. The high-power pulse laser 110 allows respective components or elements constituting the aerosol particles to be concurrently subjected to desorption and ionization. A nano-second laser operated for several nanoseconds or so is most widely used as the high-power pulse laser 110. In the case where the high-power pulse laser 110 is a nano-second laser, there occurs a time delay of 100 to 300 nsec or more between the preliminary operation time (lamp) and the actual operation time (Q-switching), and hence it is required to appropriately control the time delay so as to increase the probability of ionization. Also, the high-power pulse laser is made stably operative so that the protection of the laser and the stable supply of energy can be ensured.

The mass spectrometer system according to the present invention may implement other types of particle ionization and ion extracting/accelerating apparatuses so as to increase the ion mass resolution.

The ionization apparatus electronically ionizes the aerosol particles to generate ions using the speed of the aerosol particles measured by the optical system 105 and 106. The ionization apparatus first allows optical signals outputted from light sources of two continuous-wave lasers 105 and scattered by the aerosol particles to be applied to two optical sensors 106 disposed higher in an orthogonal direction so as to measure two scattered optical signals. The speed of the particles can be measured based on a time interval between the two optical signals and the distance between the two continuous light sources. Then, transistor-transistor logic (TTL) signals having different time delays are generated to operate the high-power pulse laser 110 whose focal point is focused on a position which is twice as far as the distance between the two continuous-wave lasers 105 based on the measurement result of particle speed. The present invention enables the control of the time delay between the lamp signal and the Q-switching signal since the time delay varies depending on the kind of the high-power pulse laser 110.

The initial speed of the ions generated by the high-power pulse laser 110 is determined by the temperature characteristic of a laser-induced plasma. At this time, although all the ions are generated at the same speed, the ions progress in all directions unlike other mass spectrometers (for example, laser ablation time-of-flight mass-spectrometer (LA-TOF-MS)) to thereby obtain other effects. Specifically, since the ions progressing in an opposite direction to that of a TOF chamber are reflected by the ion-reflecting electrode plate 107 positioned in the opposite direction so the ions return to an original position, the effect is the same as that of the ions progressing in a 0-degree direction, namely, the effect in which the ions have different time delays occurring therebetween at the same position. However, in the case of ions progressing at a certain angle between 0 and 180 degrees, as long as the dimension of the ion sensor 113 is sufficiently large, the ions can be regarded as ions generated at the same point while having different initial energies and different time delays occurring therebetween on the assumption that the ion speed in an orthogonal direction is ignored.

The ions induced by the laser are extracted and progress in a TOF chamber direction due to a difference in voltage potential applied across the ion-reflecting electrode plate 107 and the ion-extracting electrode plate 108. In this case, although the progressing ions have the same charges as well as masses, they reach the ion sensor 113 at different points in time due to different initial energies and a difference in ion generation time, resulting in a degradation in mass resolution.

Therefore, the present invention is designed so that all the ions having the same mass and charge reach the ion sensor at the same time to improve the mass resolution.

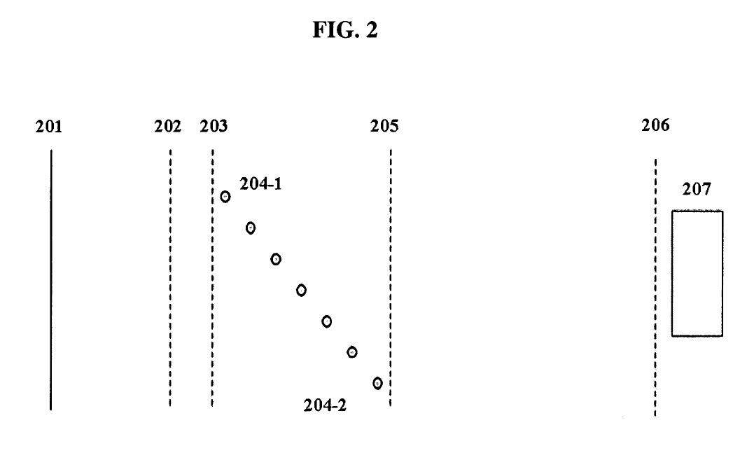

FIG. 2 is a schematic diagrammatic view illustrating the construction of an ion post-focusing apparatus in a mass spectrometer system according to the present invention.

Referring to FIG. 2, charged particles or ions are generated between a positive ion-reflecting plate 201 and an ion-extracting plate 202 by means of ablation by a high-power pulse laser (not shown). The positive ion-reflecting plate 201 serves to absorb electrons and reflect positive ions. The positive ions reflected by the positive ion-reflecting plate 201 are moved toward the ion-extracting plate 202 while being accelerated. The moved positive ions are accelerated while passing through a primary ion-accelerating plate 203 to obtain energy. The respective accelerated ions rapidly pass through the primary ion-accelerating plate 203 at different times depending on their initial directions, and then penetrate into a secondary ion post-focusing plate 205 region. Even in the case of ions having the same energy, an ion 204-2 whose initial direction is 0 degree reaches the boundary region of the secondary ion post-focusing plate 205 the earliest, and an ion 204-1 whose initial direction is 180 degree penetrates into the primary ion-accelerating plate 203 the latest so as to remain at the entrance of the secondary ion post-focusing plate 205. When all the ions enter the secondary ion post-focusing plate 205 region, a non-linear voltage is applied across the primary ion-accelerating plate 203 and the secondary ion post-focusing plate 205. At this time, the generated electric field is very important, and should be determined appropriately in magnitude and range. Thereafter, all the ions pass through an electric field-free region, i.e., a space between the secondary ion post-focusing plate 205 and the TOF free electromagnetic field electrode plate 206, and then are incident on the ion sensor 207. The ion sensor 207 detects the mass of the incident ions.

The ion post-focusing apparatus according to the present invention applies an accelerating voltage across the primary ion-accelerating plate 203 and the secondary ion post-focusing plate 205 to generate different electric fields depending on the position of each ion so as to add different energies to the ions in an ion post-focusing region, respectively, so that the ions, whose initial energies and initial directions (ranging from 0 to 360 degrees) are different from one another, respectively, can reach the ion sensor 207 concurrently.

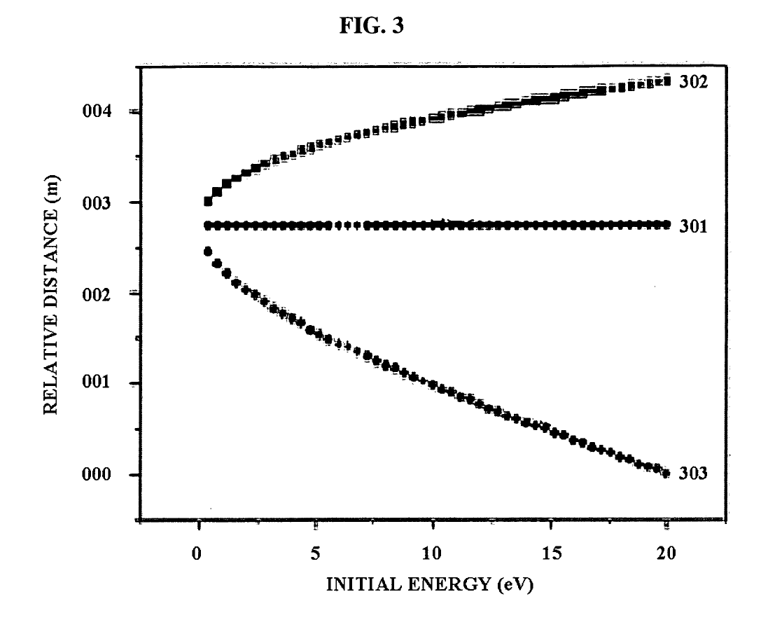

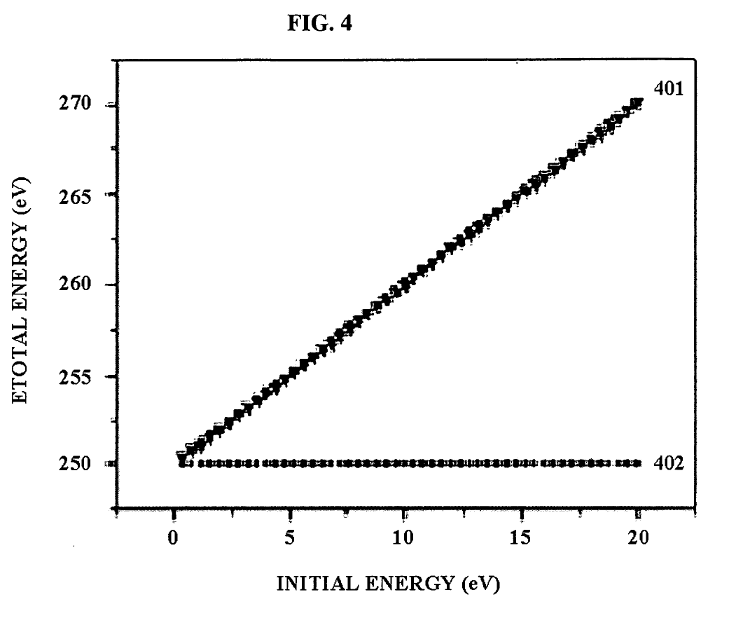

After having passed through the primary ion-accelerating plate 203, the ions move in a constant velocity, and the position and the energy of the ions at the point in time when the last ion reaches the secondary ion post-focusing plate 205 are shown in FIGS. 3 and 4.

FIG. 3 is a graph illustrating a difference in position of packets of ions based on the time when the last ion passes through the primary ion-accelerating plate 203 in the case where the ions whose initial energy ranges from 0 to 20 eV progress in 0-, 90-, and 180-degree directions with respect to the TOF chamber direction.

Referring to FIGS. 3 and 4, an ion whose initial energy is 20 eV and initial direction is 180 degree passes through the primary ion-accelerating plate 203 the latest. Since the ions passing through the primary ion-accelerating plate 203 are not applied with a post-focusing electric field until the last ion reaches the primary ion-accelerating plate 203, they move in a constant velocity, respectively. Thus, the respective ions pass through the ion post-focusing region at the same speed as when passing through the primary ion-accelerating plate 203. Then, the positions of the respective ions can be theoretically calculated. In the case no ions progressing in 90 to 180 degree directions exist, similar to when irradiating a laser beam onto a metal plate, the position of respective ions passing through the primary ion-accelerating plate 203 is distributed so that ions whose initial energy is large are arranged uniformly.

Conversely, the space distribution of ions which reach the secondary ion post-focusing plate 205 while being scattered in all directions is shown in FIG. 3.

Referring to FIG. 3, the ions 302 incident on the secondary ion post-focusing plate 205 in 0-degree direction are in a state of progressing to the farthest point away from the secondary ion post-focusing plate 205, the ions 303 incident on the secondary ion post-focusing plate 205 in 180-degree direction are in a state of progressing to the nearest point to the secondary ion post-focusing plate 205, and the ions 301 incident on the secondary ion post-focusing plate 205 in 90-degree direction are in a state of exiting at the same position from the secondary ion post-focusing plate 205 at the same time c

In the case of using the secondary ion post-focusing apparatus according to the present invention, the time when all the ions progressing at an arbitrary speed in an arbitrary direction reach the ion sensor 207 is related with the position, the kinetic energy and the magnitude of the ion post-focusing electric field of respective ions immediately before the ion post-focusing is performed.

FIG. 4 is a graph illustrating the total energy distribution of packets of ions before the secondary ion post-focusing process is performed in a mass spectrometer system according to the present invention.

Referring to FIG. 4, the kinetic energy of ions whose initial direction is 0 degrees is identical to that of ion whose initial direction is 180 degrees, and the kinetic energy of ions whose initial direction is 90 degrees are the smallest. It can be understood that the kinetic energy and the position of packets of ions whose initial direction ranges from 90 to 180 degrees are different in effect from those of packets of ions whose initial direction ranges from 0 to 90 degrees in the same electric field. That is, when an electric field is applied in a direction of decreasing the kinetic energy in a spatially uniform electric field, there a decreased time difference between packets of ions whose initial direction ranges from 0 to 90 degrees whereas there is an increased time difference between packets of ions whose initial direction ranges from 90 to 180 degrees. Specifically, it can be seen that in the case of applying a certain electric field to the ions, only the arrival time of packets of ions whose initial direction is uniform can reduce a time difference between the ion packets.

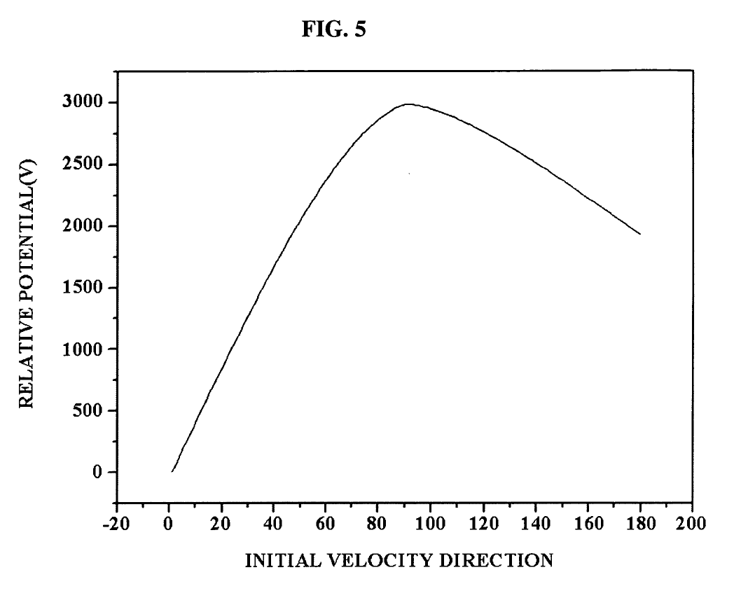

FIG. 5 is a graph illustrating the magnitude of the voltage applied to ion packets whose initial direction ranges from 0 to 90 degrees and ion packets whose initial direction ranges from 90 to 180 degrees.

Referring to FIG. 5, the present invention is designed so that voltage is applied in different directions with respect to a 90 degree direction dissimilarly to the conventional method. When different voltages are non-linearly applied to different ion packets, two ion packets can reach to ion sensor at the same time.

That is, the ion post-focusing apparatus uses an electric field which is non-linear in terms of the magnitude of deceleration of ions whose initial direction ranges from 90 to 180 degrees and the magnitude of acceleration of ions whose initial direction ranges from 0 to 90 degrees based on ion packets whose initial direction is 90 degree with respect to the TOF chamber direction.

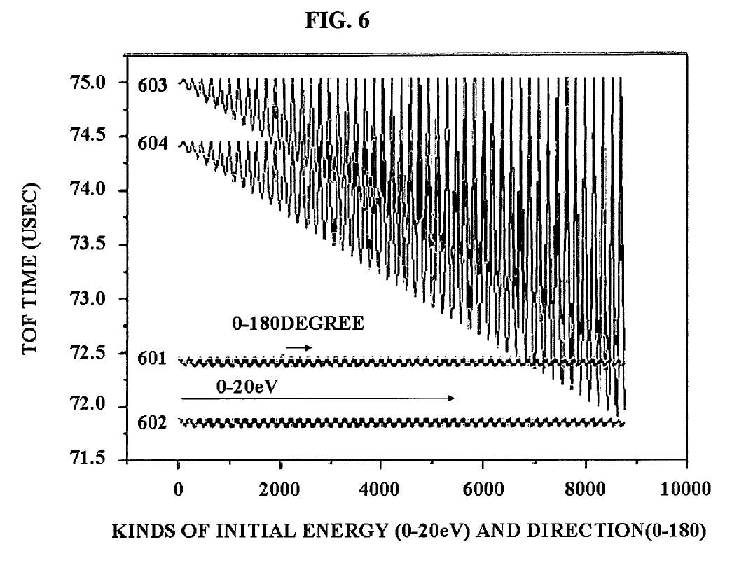

FIG. 6 is a timing graph illustrating waveforms of TOF signals of various ions whose initial energies and initial directions are different from one another, respectively, in a mass spectrometer system according to the present invention.

Referring to FIG. 6, a first signal 601 is a TOF signal obtained when a non-linear voltage is applied to ion packets whose mass is 65, a second signal 602 is a TOF signal obtained when a non-linear voltage is applied to ion packets whose mass is 64. The first and second signals 601 and 602 enable theoretical calculation of the TOF time obtained when a non-linear voltage is applied to ion packets as shown in FIG. 5. A third signal 603 is a TOF signal obtained when a constant voltage is applied to ion packets whose mass is 65, and a fourth signal 604 is a TOF signal obtained when a constant voltage is applied to ion packets whose mass is 64. The third and fourth signals 603 and 604 greatly vary depending on the initial movement direction of the ions when a constant electric field is applied to the secondary ion post-focusing plate.

It can be seen that in the case of application of a non-linear voltage as shown in FIG. 5, all the ions can reach the ion sensor at the same time regardless of the initial energy and the initial direction of the ions such that ions whose masses are different may reach the ion sensor at times where the ions may be discriminated from one another.

Accordingly, the present invention allows an electric field to be applied to ions in opposite directions, i.e., in respective directions in which ions whose directions are 180 degrees and 0 degrees based on ion packets whose movement direction is 90 degrees irrespective of the initial energy and direction of the ions, so that the ions having different energies and all directionalities can reach the ion sensor at the same time. That is, the ion post-focusing apparatus applies a decelerating electric filed to ions whose initial direction ranges from 90 to 180 degrees and applies an accelerating electric field to ions whose initial direction ranges from 0 to 90 degrees based on ion packets whose initial direction is 90 degree with respect to the TOF chamber direction.

As such, the present invention applies an accelerating voltage across the primary ion-accelerating plate and the secondary ion post-focusing plate to generate different electric fields through the ion post-focusing apparatus depending on the position of respective ions so as to add different energies to the ions in an ion post-focusing region, respectively, so that the ions whose initial energies and initial directions are different from one another, respectively, can reach the ion sensor concurrently.

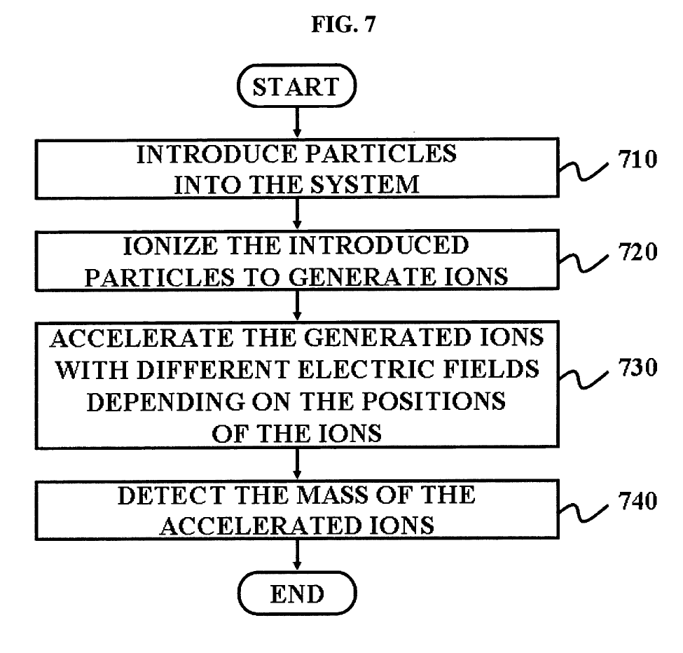

FIG. 7 is a flowchart illustrating a mass spectrometry process performed using a mass spectrometer system according to one embodiment of the present invention.

Referring to FIG. 7, in operation 710, the mass spectrometer system introduces particles to be analyzed thereinto.

Next, in operation 720, the mass spectrometer system ionizes the introduced particles to generate ions.

Subsequently, in operation 730, the mass spectrometer system accelerates the generated ions with different electric fields depending on the respective positions of the ions. The inventive mass spectrometer system can apply a decelerating electric filed to ions whose initial direction ranges from 90 to 180 degrees and applies an accelerating electric field to ions whose initial direction ranges from 0 to 90 degrees based on ion packets whose initial direction is 90 degree with respect to the TOF chamber direction. Also, the inventive mass spectrometer system can use an electric field which is non-linear in terms of the magnitude of deceleration of ions whose initial direction ranges from 90 to 180 degrees and the magnitude of acceleration of ions whose initial direction ranges from 0 to 90 degrees based on ion packets whose initial direction is 90 degree with respect to the TOF chamber direction. Therefore, the inventive mass spectrometer system can add different energies to the ions in an ion post-focusing region, respectively, so that the ions whose initial energies and initial directions (ranging from 0 to 360 degrees) are different from one another, respectively, and can reach the ion sensor 207 concurrently.

Lastly, in operation 740, the mass spectrometer system analyzes the ions which are accelerated and reach the ion sensor.

As described above, according to the present invention, the inventive mass spectrometer system uses a non-linear ion post-focusing apparatus to cause even ions whose initial energies and initial directions are different from one another to be incident on the TOF ion sensor concurrently, thereby increasing the resolution of the mass-to-charge of ions.

In addition, according to the present invention, since the inventive mass spectrometer system is simpler in configuration of the system due to application of a static voltage as compared to application of a dynamic voltage, which makes it possible to easily and simply manufacture the system at a low cost.

Furthermore, according to the present invention, since the inventive mass spectrometer system can be implemented so that even ions progressing in different directions reach the ion sensor at the same time, the efficiency of the entire system is increased, which makes it possible to analyze the components of even very small nano-sized particles that have a small number of ions.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A mass spectrometer system comprising:
an ion-introducing unit for introducing particles into the mass spectrometer system;
an ionization unit for ionizing the introduced particles to generate ions;
an ion-accelerating unit for accelerating the generated ions with different electric fields depending on respective positions of the ions; and
an ion mass detector for detecting mass of the accelerated ions.

2. The mass spectrometer system of claim 1, wherein the ion-accelerating unit applies different energies to particles that are differently distributed spatially depending on the initial energy of the ions.

3. The mass spectrometer system of claim 1, wherein the ion mass detector comprises an ion sensor, and the ion-accelerating unit accelerates the ions whose initial energies and initial directions are different from one another, respectively, so that they reach the ion sensor concurrently.

4. The mass spectrometer system of claim 1, wherein the ion-accelerating unit decelerates ions whose initial direction ranges from 90 to 180 degrees and accelerates ions whose initial direction ranges from 0 to 90 degrees based on ion packets whose initial direction is 90 degree with respect to a Time-of-Flight (TOF) chamber direction.

5. The mass spectrometer system of claim 1, wherein the ion-accelerating unit uses an electric field which is non-linear in terms of a magnitude of deceleration of ions whose initial direction ranges from 90 to 180 degrees and a magnitude of acceleration of ions whose initial direction ranges from 0 to 90 degrees based on ion packets whose initial direction is 90 degree with respect to a TOF chamber direction.

6. The mass spectrometer system of claim 1, wherein the ion-accelerating unit comprises:
a primary ion-accelerating plate for allowing the generated ions to pass therethrough to primarily accelerate the passed ions; and
a secondary ion post-focusing plate to secondarily accelerate the ions that have passed through the primarily ion-accelerating plate,
wherein a non-linear voltage is applied across the primary ion-accelerating plate and the secondary ion post-focusing plate.

7. A non-linear ion post-focusing apparatus for a mass spectrometer system, comprising:
a primary ion-accelerating plate for allowing ions of particles introduced into the mass spectrometer system to pass therethrough to primarily accelerate the passed ions; and
a secondary ion post-focusing plate to secondarily accelerate the ions that have passed through the primary ion-accelerating plate with different ion post-focusing electric fields depending on respective positions of the ions,
wherein the ion post-focusing electric fields decelerates ions whose initial direction ranges from 90 to 180 degrees and accelerates ions whose initial direction ranges from 0 to 90 degrees based on ion packets whose initial direction is 90 degree with respect to a (TOF) chamber direction.

8. The non-linear post-focusing apparatus of claim 7, wherein each of the different ion post-focusing electric fields is an electric field which is non-linear in terms of a magnitude of deceleration of ions whose initial direction ranges from 90 to 180 degrees and a magnitude of acceleration of ions whose initial direction ranges from 0 to 90 degrees based on ion packets whose initial direction is 90 degree with respect to the TOF chamber direction.

9. A mass spectrometry method using a mass spectrometer system, comprising:
introducing particles into the mass spectrometer system;
ionizing the introduced particles to generate ions;
accelerating the generated ions with different electric fields depending on respective positions of the ions; and
detecting the mass of the accelerated ions.

10. The mass spectrometry method of claim 9 wherein the accelerating the generated ions comprises:
decelerating ions whose initial direction ranges from 90 to 180 degrees, and accelerating ions whose initial direction ranges from 0 to 90 degrees based on ion packets whose initial direction is 90 degree with respect to a TOF chamber direction.

11. The mass spectrometry method of claim 9 wherein each of the different ion post-focusing electric fields is an electric field which is non-linear in terms of a magnitude of deceleration of ions whose initial direction ranges from 90 to 180 degrees and a magnitude of acceleration of ions whose initial direction ranges from 0 to 90 degrees based on ion packets whose initial direction is 90 degree with respect to a TOF chamber direction.
